(19) United States
(12) Patent Application Publication
(10) Pub. No.: US 2012/0147104 A1
(43) Pub. Date: Jun. 14, 2012

(54) Cartridge for Inkjet Printer

(76) Inventors: Feng Ouyang, Zhuhai (CN); Jiedong Zheng, Zhuhai (CN)

(21) Appl. No.: 13/391,815

(22) PCT Filed: Dec. 23, 2009
(86) PCT No.: PCT/CN2009/075878

§ 371 Date: Feb. 22, 2012

(51) Int. Cl. B41J 2/175

(52) U.S. Cl. 347/86

(57) ABSTRACT

A cartridge for inkjet printer includes housing and an ink storage tank defined inside the housing. An ink outlet is defined in the bottom portion of the housing, while an air inlet and ink inlet are formed on the top portion of the housing. All of the ink outlet, air inlet and ink inlet are communicated with the ink storage tank. A filtration chamber is defined in the ink storage tank. A filtration core is provided in the filtration chamber. The chamber is communicated with a flow guiding slot disposed at one side of the ink storage tank through a filtration hole. The other end of the flow guiding slot is communicated with the ink outlet. Advantageously, bubbles genreated during operation of the cartridge can be stored in the bubble chamber of the housing, thus eliminating bad effect of the bubbles on the normal flow of the ink out of the ink outlet. On the other hand, when the ink storage tank is full of ink, the longitudinal and horizontal separation plates, pressure reduction chamber and filtration hole can effectively reduce liquid pressure, thus keeping ink pressure at the ink outlet substantailly constant, making supply of the ink more evenly, and extending the life of the cartridge. Additionally, better printing quality can be realized.

### FIELD OF THE INVENTION

The invention relates to a printing device and more particularly relates to a cartridge for inkjet printer.

### BACKGROUND OF THE INVENTION

Prior art cartridge used for an inkjet printer generally includes housing and an ink storage tank defined in the housing. An ink outlet is defined in the bottom portion of the housing, while an an inlet and ink inlet are formed on the top portion of the housing. All of the ink outlet, air inlet and ink inlet are communicated with the ink storage tank. The ink storage tank is sealed with a film when the tank is full of ink. When in operation, air enters into the ink storage tank and then bubbles are generated. These bubbles adversely affect flowing of the ink out of the ink outlet, thereby bringing bad effects on printing quality. On the other hand, ink pressure of the ink outlet will become large when the ink storage tank is full of ink. As a result, excessive amounts of ink flow from the tank. In addition, the print words are darkened greatly. Moreover, the lifespan of the cartridge is reduced.

### SUMMARY OF THE INVENTION

One object of the invention is to provide a cartridge for inkjet printer which is capable of supplying ink more evenly, has a long lifespan, and can bring better printing quality.

To achieve the above object, the following technical solution is provided.

A cartridge for inkjet printer includes housing and an ink storage tank defined inside the housing. An ink outlet is defined in the bottom portion of the housing, while an air inlet and ink inlet are formed on the top portion of the housing. All of the ink outlet, air inlet and ink inlet are communicated with the ink storage tank. A filtration chamber is defined in the ink storage tank. The chamber is communicated with a flow guiding slot disposed at one side of the ink storage tank through a filtration hole. The other end of the flow guiding slot is communicated with the ink outlet.

Preferably, the flow guiding slot is defined horizontally on the housing. One end, which is connected with the ink outlet, of the flow guiding slot has a bubble chamber defined therein. The width of the bubble chamber is greater than that of the flow guiding slot.

Preferably, the diameter of the filtration hole is larger than width of the flow guiding slot.

Preferably, a filtration core is placed in the filtration chamber.

Preferably, the ink storage tank has a longitudinal separation plate and horizontal plate disposed therein, the two plates being connected with each other. At least one notch is defined in the longitudinal or horizontal separation plate.

Preferably, the horizontal separation plate has an angled wall. The angled wall, the horizontal separation plate and the bottom portion of the ink storage tank together form a pressure reduction chamber communicating with the filtration chamber.

Preferably, a longitudinal separation plate and a crossed horizontal separation plate are formed in the ink storage tank. A notch is defined in the longitudinal or horizontal separation plate.

Preferably, a one-way valve is disposed on the housing. The air inlet of the housing is communicated to the ink storage tank via said one-way valve.

Compared with prior art, the invention has the following advantages. Bubbles generated during operation of the cartridge can be stored in the bubble chamber of the housing, thus eliminating bad effect of the bubbles on the normal flow of the ink out of the ink outlet. On the other hand, when the ink storage tank is full of ink, the longitudinal and horizontal separation plates, pressure reduction chamber and filtration hole can effectively reduce liquid pressure, thus keeping ink pressure at the ink outlet substantailly constant, making supply of the ink more evenly, and extending the life of the cartridge. Additionally, better printing quality can be realized.

### BRIEF DESCRIPTION OF THE DRAWINGS

FIG. 1 shows a schematic view of the construction of the cartridge of the invention;

FIG. 2 shows a top plan view of the construction of FIG. 1; and

FIG. 3 shows schematically a bottom plan view of the construction of FIG. 1.

### DETAILED DESCRIPTION OF THE INVENTION

Various embodiments of the invention will be described below in further detail with reference to the accompanying drawings.

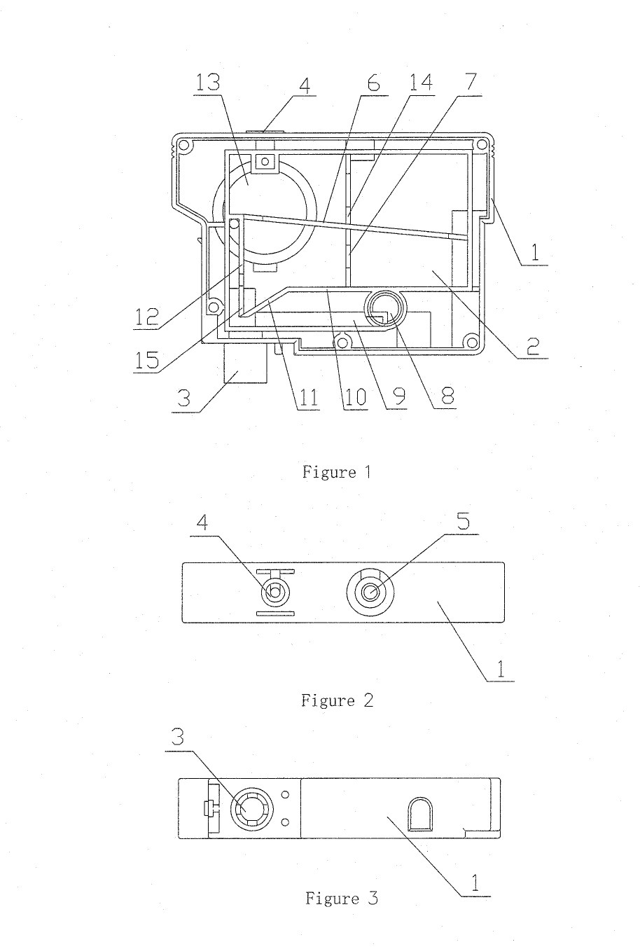

Referring to FIGS. 1-3, a cartridge for inkjet printer includes housing 1 and an ink storage tank 2 defined inside the housing 1. An ink outlet 3 is defined in the bottom portion of the housing 1, while an air inlet 4 and ink inlet 5 are formed on the top portion of the housing 1. All of the ink outlet 3, air inlet 4 and ink inlet 5 are communicated with the ink storage tank 2. A one-way valve 13 is disposed on the housing 1. The air inlet 4 of the housing 1 is communicated to the ink storage tank 2 via said one-way valve 13. A filtration chamber 8 is defined in the ink storage tank 2. The chamber 8 is communicated with a flow guiding slot disposed at one side of the ink storage tank 2 through a filtration hole. The other end of the flow guiding slot is communicated with the ink outlet 3.

In the embodiment of the invention, the flow guiding slot is defined horizontally on the housing 1. One end, which is connected with the ink outlet 3, of the flow guiding slot has a bubble chamber defined therein. The width of the bubble chamber is greater than that of the flow guiding slot. The bubble chamber functions to accommodate bubbles generated due to entrance of air. A filtration core is placed in the filtration chamber 8. The diameter of the filtration hole is greater than width of the flow guiding slot.

The ink storage tank 2 has a longitudinal separation plate 12 and horizontal plate 10 disposed therein, the two plates being connected with each other. The horizontal separation plate 10 has an angled wall 11. A notch 15 is defined at a location where the longitudinal and horizontal separation plates are connected with each other. The angled wall 11, the horizontal separation plate 10 and the bottom portion of the ink storage tank 2 together form a pressure reduction chamber 9 communicating with the filtration chamber 8. A longitudinal separation plate 7 and a crossed horizontal separation plate 6 are formed in the ink storage tank 2. Plural notches 14, 15 are defined in the longitudinal plate 7 or horizontal separation plate 6. The notches 14 and 15, pressure reduction chamber 9, filtration chamber 8, and flow guiding slot together define a path along which the ink runs, thus effectively making the liquid pressure decreased, keeping ink pressure at the ink outlet substantailly constant, making supply of the ink more evenly, and extending the life of the cartridge. Additionally, better printing quality can be realized.

1. A cartridge for inkjet printer comprising a housing and an ink storage tank defined inside the housing, wherein an ink outlet is defined in the bottom portion of the housing, while an air inlet and ink inlet are formed on the top portion of the housing; all of the ink outlet, air inlet and ink inlet are communicated with the ink storage tank; a filtration chamber is defined in the ink storage tank; the chamber is communicated with a flow guiding slot disposed at one side of the ink storage tank through a filtration hole, and the other end of the flow guiding slot is communicated with the ink outlet.

2. The cartridge according to claim 1, wherein the flow guiding slot is defined horizontally on the housing; and one end, which is connected with the ink outlet, of the flow guiding slot has a bubble chamber defined therein; the width of the bubble chamber is greater than that of the flow guiding slot.

3. The cartridge according to claim 1, wherein the diameter of the filtration hole is larger than width of the flow guiding slot.

4. The cartridge according to claim 1, wherein a filtration core is placed in the filtration chamber.

5. The cartridge according to claim 1, wherein the ink storage tank has a longitudinal separation plate and horizontal plate disposed therein, the two plates being connected with each other: and at least one notch is defined in the longitudinal or horizontal separation plate.

6. The cartridge according to claim 5, wherein the horizontal separation plate has an angled wall; the angled wall, the horizontal separation plate and the bottom portion of the ink storage tank together form a pressure reduction chamber communicating with the filtration chamber.

7. The cartridge according to claim 1, wherein a longitudinal separation plate and a crossed horizontal separation plate are formed in the ink storage tank; and a notch is defined in the longitudinal or horizontal separation plate.

8. The cartridge according to claim 1, wherein a one-way valve is disposed on the housing; and the air inlet of the housing is communicated to the ink storage tank via said one-way valve.
